(19) United States
(12) Patent Application Publication
(10) Pub. No.: US 2009/0206260 A1
(43) Pub. Date: Aug. 20, 2009

(54) Night vision technology: broad band imaging

(76) Inventors: Brandon Hite, Albuquerque, NM (US); John D. Taylor, Colorado Springs, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/322,614

(22) Filed: Feb. 4, 2009

Related U.S. Application Data
(60) Provisional application No. 61/063,557, filed on Feb. 4, 2008.

(51) Int. Cl. H01L 31/00; G01J 1/42; G01J 5/02; G01J 5/00

(52) U.S. Cl. 250/330; 250/372; 250/339.06; 250/338.1

(57) ABSTRACT

The invention is directed to a night vision system that has an illuminator that transmits light towards a target using light outside the visible spectrum. A receive optics focuses an image on a charge coupled device. This system with an ultraviolet illuminator allows the night vision system to view images beyond 2500 meters, while present systems are limited to around 800 meters. The illuminator is generally a high peak power pulsed light source. A processor uses frame addition techniques to increase the captured light and may use binning techniques to increase the signal to noise ratio. The system may use multiple illuminators and capture images at a number of different wavelengths.

### RELATED APPLICATIONS

The present invention claims priority on provisional patent application, Ser. No. 61/063557, filed on Feb. 4, 2008, entitled “Novel Night Vision Technology: Broad Band Imaging” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Night vision systems have provided a significant advantage for our troops. There are two general types of night vision system. One night vision system amplifies the small amount of ambient light at nighttime. These systems are able to amplify light in the near infrared spectrum as well as visible light. The second night vision system detects the light given off by heat. The heat signature gives off infrared light in the long wavelength infrared section of the spectrum. The first image intensifying technology is limited by the amount of ambient light and therefore has a limited range. The second, heat imaging, technology has historically been limited by the need to cryogenically cool the detector. Also the range and resolution has been deteriorated by water vapor absorption of the light, large ambient noise and the wavelength of the received light. There have been attempts to combine these two types of technologies, however the image integration only occurs after the image has been separately processed by each type of technology. As a result, these systems are large and cumbersome.

Thus there exists a need for a night vision system that has a broad band image, improved range and resolution.

### BRIEF SUMMARY OF INVENTION

A night vision system that overcomes these and other problems has an illuminator that transmits light towards a target using light outside the visible spectrum. A receive optics focuses an image on a charge coupled device. This system with an ultraviolet illuminator allows the night vision system to view images beyond 2500 meters, while present systems are limited to around 800 meters. The illuminator is generally a high peak power pulsed light source. A processor uses frame addition techniques to increase the captured light and may use binning techniques to increase the signal to noise ratio. The system may use multiple illuminators and capture images at a number of different wavelengths.

### BRIEF DESCRIPTION OF THE SEVERAL VIEWS OF THE DRAWINGS

FIG. 1 is a block diagram of a night vision system with broad band imaging in accordance with one embodiment of the invention;

FIG. 2 is a block diagram of a night vision system with broad band imaging in accordance with one embodiment of the invention; and

FIG. 3 is a spectral diagram of the night vision system with broad band imaging in accordance with one embodiment of the invention.

### DETAILED DESCRIPTION OF THE INVENTION

The invention is directed to a night vision system that has an illuminator that transmits light towards a target using light outside the visible spectrum. A receive optics focuses an image on a charge coupled device. This system with an ultraviolet illuminator allows the night vision system to view images beyond 2500 meters, while present systems are limited to around 800 meters. The illuminator is generally a high peak power pulsed light source. A processor uses frame addition techniques to increase the captured light and may use binning techniques to increase the signal to noise ratio. The system may use multiple illuminators and capture images at a number of different wavelengths.

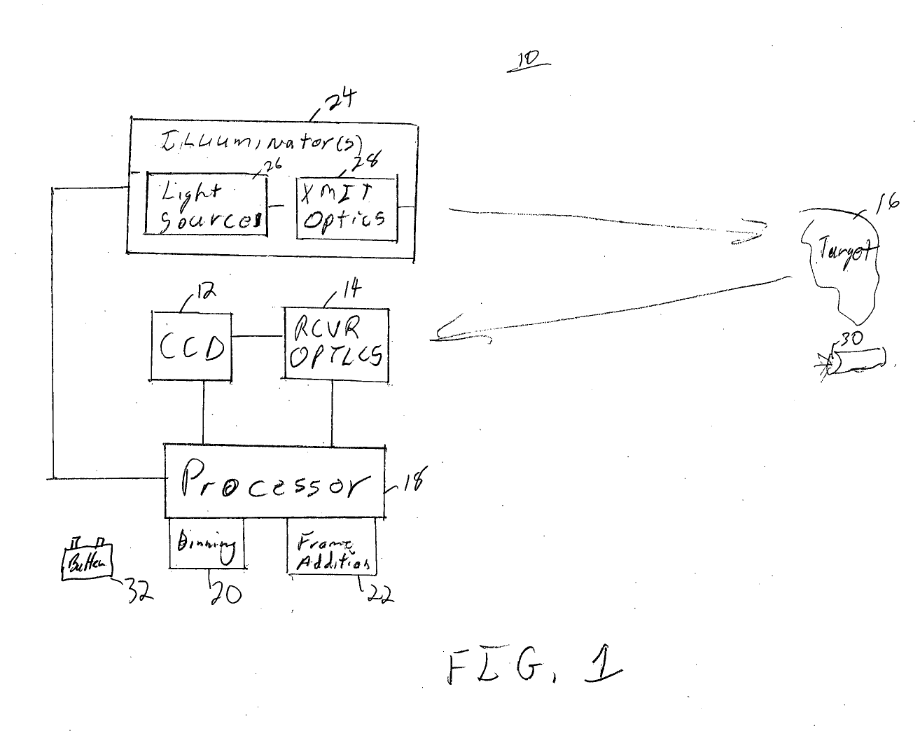

FIG. 1 is a block diagram of a night vision system 10 with broad band imaging in accordance with one embodiment of the invention. The system 10 includes a charge coupled device (CCD) 12 or other multi-pixel detector. A receive optics 14 focus an image of a target 16 on the CCD 12. The CCD 12 is coupled to a processor 18. The processor 18 stores images and can do additional image processing such as binning techniques 20 and frame addition techniques 22. Binning techniques 20 group pixels together to form the image, this allows for faster readout and better signal to noise ratios. Frame addition 22 is a technique of adding the signal from several snap shots together to increase the light collected. The processor 18 may also be connected to the receive optics 14 to control fields of view and focus. The system 10 also has an illuminator 24 or multiple illuminators. The illuminator 24 includes a light source 26 and a transmit optics 28. The illuminator 24 may be coupled to the processor 18 or have its own processor. The processor 18 may control when the illuminator 24 directs its light at a target 16. In one embodiment, the target 16 may be facing optics 30. Facing optics could include a telescopic sight, infrared system or other imaging or viewing device. The light source 26 is generally a high peak power pulsed source with a low duty cycle to save energy. In addition, the light source 26 is outside the visible spectrum. The light source 26 may emit light in the infrared region or in the ultraviolet region. The CCD 12 is a wide spectrum CCD 12 that detects light in the range from 100 um to 192 nm. In one embodiment, the system is powered by a battery 32 and therefore power conservation is important to keeping the system lightweight. The transmit and receive optics 28, 14 may be coated with an antireflection coating to increase their performance at selected wavelengths.

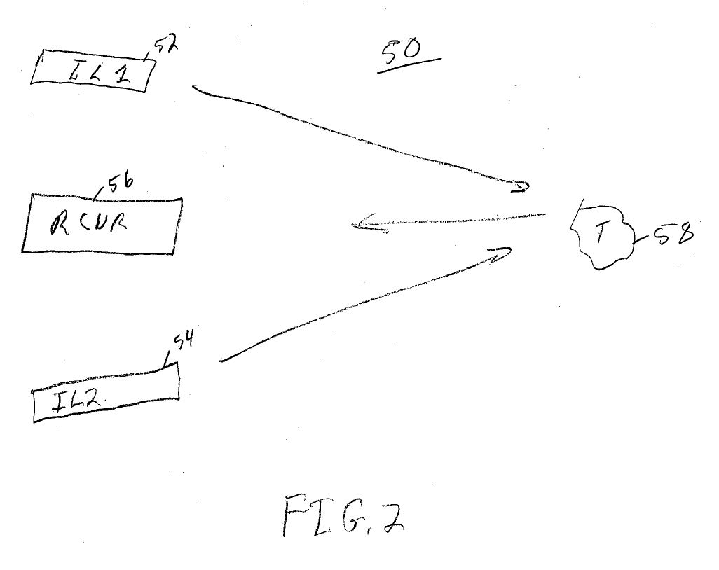

FIG. 2 is a block diagram of a night vision system 50 with broad band imaging in accordance with one embodiment of the invention. This figure shows that there can be multiple illuminators 52, 54. The illuminators 52, 54 may be spaced from the receiver 56, which includes the receive optics and the CCD. By spacing the illuminators 52, 54 away from the receive optics, the illuminators cannot be used to pinpoint the position of the receiver 56. Commonly, the illuminators 52, 54 would be operating at different wavelengths. For instance, one of the illuminators 52 may be operating in the mid infrared region, while the other illuminator 54 would be operating in the ultraviolet region. Having multiple illuminators at different wavelengths can provide different information about the target 58. For instance, if one illuminator works in the mid-infrared range the receiver 56 will pick up difference in heat, which would not be visible in the ultraviolet spectrum. Alternatively, an illuminator that works in the ultraviolet might result in a large reflection from facing optics that would not be seen in mid-infrared region. In addition, an ultraviolet illuminator will cause fluoresces in some objects, which will allow them to be viewed. The illuminators allow the night vision system 10 & 50 to image targets out to 2500 meters with wide fields of view, while present night vision system are limited to about 800 meters with narrow fields of view.

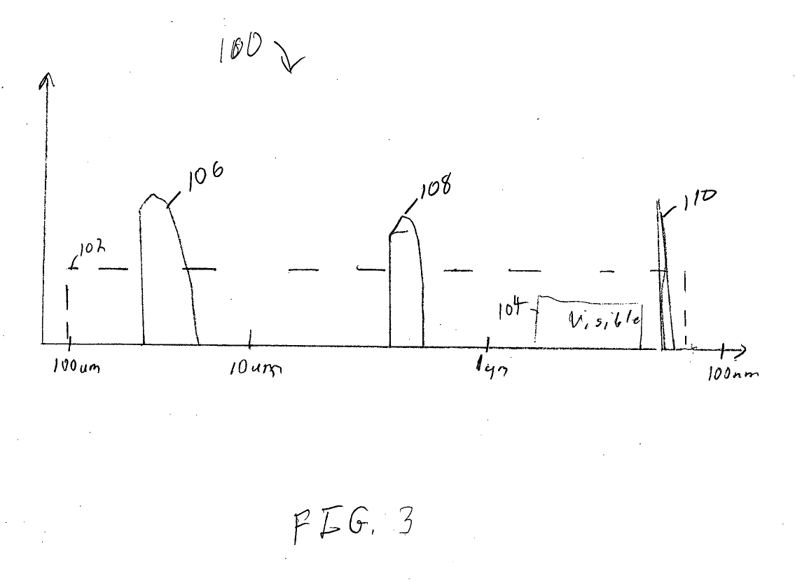

FIG. 3 is a spectral diagram 100 of the night vision system with broad band imaging in accordance with one embodiment of the invention. The spectral range of the CCD is shown as the dashed line 102. While the response of the CCD is shown as flat, the actual response across this range of wavelengths will vary. The processor may use various image processing techniques to compensate for the variation in the spectral response of the CCD, including frame addition techniques. The visible spectrum 104 is shown on the right side of the graph. The CCD is capable of detecting the visible spectrum 104, however this is not the main area of interest for this application. The peaks 106, 108, 110, are meant to show the output of the illuminators. Note that short wavelength illumination and detection results in better image resolution than long wavelengths. Right now there are almost no systems attempting to view in the ultraviolet range. As a result, an illuminator in the ultraviolet range is more covert than illuminators in the infrared region. Furthermore, an ultraviolet illuminator will have a smaller beam width and smaller side lobes than lower frequency illuminators and as a result has a lower probability of intercept.

Thus there has been described a night vision system that has a broad band image, improved range and resolution.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A night vision system with broad band imaging, comprising:
a charge coupled device;
a receive optics focusing an image on the charge coupled device; and
an illuminator transmitting light outside the visible spectrum at a target.

2. The system of claim 1, wherein the illuminator is a pulsed light source.

3. The system of claim 2, wherein the pulsed light source has an ultraviolet output.

4. The system of claim 2, wherein the pulsed light source has an infrared output.

5. The system of claim 1, wherein the illuminator includes a light source and a transmit optics.

6. The system of claim 1, further including a processor that uses a frame addition technique.

7. A night vision system with broad band imaging, comprising:
a multi-pixel detector;
a receive optics with anti-reflection coating focusing an image on the multi-pixel detector; and
an illuminator transmitting a light at a target, wherein the light is not in the visible spectrum.

8. The system of claim 7, wherein the multi-pixel sensor is a charge coupled device.

9. The system of claim 7, further including a plurality of illuminators, each of the illuminators using a different spectrum of light.

10. The system of claim 8, wherein the illuminator includes a light source and a transmit optics.

11. The system of claim 10, wherein the light source is a pulsed light source.

12. The system of claim 9, further including a processor that uses a binning technique to create an output image.

13. The system of claim 9, furthering including a processor that uses a frame addition technique to create an output image.

14. The system of claim 8, wherein the illuminator is battery powered.

15. A night vision system with broad band imagining, comprising:
an illuminator having an output light that is not in the visible spectrum;
a receive optics receiving a reflected light of the output light; and
a charge coupled device detecting an image from the receive optics.

16. The system of claim 15, wherein the illuminator includes a light source and a transmit optics.

17. The system of claim 16, wherein the reflected light is from a facing optics.

18. The system of claim 17, wherein the light source is a pulsed light source.

19. The system of claim 18, further including a processor that uses a frame addition technique to create an output image.

20. The system of claim 19, wherein the illuminator is battery powered.
